(19) United States
(12) Patent Application Publication
(10) Pub. No.: US 2003/0060383 A1
(43) Pub. Date: Mar. 27, 2003

(54) Methods for stabilizing aqueous alkylene carbonate solutions

(75) Inventors: James R. Machac JR., The Woodlands, TX (US); Susan A. Woodrum, Round Rock, TX (US); Edward T. Marquis, Austin, TX (US)

Correspondence Address: Russell R. Stolle, Huntsman Corporation, P. O. Box 15730, Austin, TX, 78761, US

(73) Assignee: Huntsman Petrochemical Corporation, Austin, TX

(21) Appl. No.: 10/243,717

(22) Filed: Sep. 13, 2002

Related U.S. Application Data
(60) Provisional application No. 60/322,696, filed on Sep. 17, 2001.

(51) Int. Cl. C11D 1/00

(52) U.S. Cl. 510/201; 510/480

(57) ABSTRACT

Provided herein are compositions containing aqueous solutions of alkylene carbonates which have been stabilized by the presence of an effective hydrolysis-inhibiting amount of an added chemical substance. By the present invention, aqueous solutions of alkylene carbonates previously unsuitable for long-term transportation and storage are rendered stable.

### CROSS-REFERENCES TO RELATED APPLICATIONS

This application claims the benefit of U.S. Provisional Application No. 60/322,696 filed Sep. 17, 2001, which is currently still pending, the entire contents of which are herein incorporated fully by reference thereto.

### FIELD OF THE INVENTION

The present invention relates to the stabilization of esters to aqueous hydrolysis. More particularly, it relates to stabilizing alkylene carbonates from aqueous hydrolysis in formulations in which alkylene carbonates are present as active ingredients.

### BACKGROUND INFORMATION

Alkylene carbonates, including without limitation ethylene carbonate, propylene carbonate, and butylene carbonate, have found utility as an ingredient in a number of multi-component formulations applications through the years. The high solvency characteristics and the low toxicity of these compounds make them especially attractive for use in a number of end use applications including but not limited to paint stripers, degreasers, and numerous other cleaning applications and formulations. However, an unfortunate property of alkylene carbonates which is well-known to those skilled in the art, is that these compounds are prone to hydrolysis in aqueous solutions. This occurs to such an extent that the employment of alkylene carbonates in aqueous solutions is prohibited, owing to product stability considerations. This aspect has left a gap in the ability to use alkylene carbonates in many uses where formulated products need to be stored for any appreciable length of time.

The hydrolysis of alkylene carbonates in general leads to the formation of carbon dioxide and the corresponding glycol. For example, the hydrolysis of propylene carbonate yields propylene glycol and carbon dioxide. The carbon dioxide produced during the hydrolysis of alkylene carbonates typically leads to pressure build up in closed systems, such as consumer-sized, sealed plastic bottles containing aqueous formulations of alkylene carbonates. This unfortunate tendency of closed containers to build pressure has limited the use of alkylene carbonates in many aqueous cleaning solutions, to cite but one example. Thus, if a method or composition were found which would render alkylene carbonates sufficiently stable to aqueous hydrolysis to enable packaging of these and other aqueous formulations containing alkylene carbonates into closed bottle packages for consumer use, such methods or compositions would enable consumer use of products which are superior in performance, and more environmentally-responsible than many of the products on the market at the time of this writing.

### SUMMARY OF THE INVENTION

The present invention relates to compositions of matter useful as a cleaning fluids which comprise: a) an alkylene carbonate; b) an effective alkylene carbonate hydrolysis-inhibiting amount of a second material selected from the group consisting of: esters, organic acids, inorganic acids, or pyrollidones; and water.

The invention provides a cleaning fluid which comprises: a) an alkylene carbonate selected from the group consisting of: ethylene carbonate; propylene carbonate; butylene carbonate; and glycerine carbonate; b) an effective alkylene carbonate hydrolysis-inhibiting amount of a second chemical species selected from the group consisting of organic acids, inorganic acids, monoesters, dibasic esters, and pyrollidones; and c) water. It is preferred that water is present in any amount between 20.00% and 95.00% by weight based upon the total weight of said composition, including every hundredth percentage therebetween. A composition according to the invention is thermally stable to the extent that the pressure in the headspace of a sealed container containing a composition of the invention is less than 3 pounds per square inch above atmospheric pressure after exposure of such sealed container containing such composition to a temperature of 50 degrees Centigrade for a time period of 12 hours.

### DETAILED DESCRIPTION

According to the invention, an effective hydrolysis-inhibiting amount of an organic acid or ester additive is added to an aqueous solution of an alkylene carbonate. The additives are preferably selected from the group consisting of: citric acid, tartaric acid, dibasic ester, N methyl pyrrolidone, ethyl lactate, 3-ethoxy propionate, methyl formate, lactic acid, phosphoric acid, or ethylene glycol diacetate. The preferred amount of the additive materials present range from about 0.01-2.00% by weight based upon the total weight of the finished composition. According to one preferred form of the invention, the preferred amount of the additive materials present ranges from about 0.01-0.20% by weight based upon the total weight of the finished composition.

One surprising aspect of the hydrolysis of alkylene carbonates contained in formulations employing different additives embraced by the invention is that there is not a clear-cut relationship between the degree of hydrolysis of aqueous alkylene carbonates and the pH of the finished compositions. Another surprising aspect is that a number of esters work well in inhibiting hydrolysis of aqueous alkylene carbonates. In fact, many of the esters out-performed their associated acid (see EC with ethyl lactate vs. EC with lactic acid).

Solutions were made containing water, propylene carbonate (“PC”), and a stabilizer. These solutions were stored at 25° C. for 16 weeks and analyzed several times during the test period. The method of analysis was gas chromatography (“GC”). Using GC, one is able determine the ratio of alkylene carbonate to glycol and thus measure the relative rate of hydrolysis from one sample to the next by measuring the relative areas on the chromatogram for each analyte. The table below lists several samples, and their results at week 16.

| Sample | PC | Water | Stabilizer | PC area % | PG area % | pH |
|---|---|---|---|---|---|---|
| 1 | 4.9 | 95 | 0.1 Phosphoric | 96.11 | 3.89 | 2.22 |
| | | | Acid | | | |
| 2 | 4.9 | 95 | 0.1 Maleic Acid | 95.67 | 4.33 | 2.19 |
| 3 | 4.9 | 95 | 0.1 L-Tataric | 95.38 | 4.62 | 2.63 |
| | | | Acid | | | |
| 4 | 4.9 | 95 | 0.1 Ethyl Lactate | 94.62 | 3.69 | 3.27 |
| 5 | 4.9 | 95 | 1.0 Ethyl Lactate | 80.25 | 4.44 | 2.47 |
| 6 | 4.0 | 95 | 1.0 EG Diacetate | 79.79 | 3.25 | 3.29 |
| 7 | 4.9 | 95 | 0.1 EEP | 93.6 | 3.31 | 4.71 |
| control | 5.0 | 95 | None | 94.43 | 5.57 | 5.26 |

A second set of solutions were made which contained water, ethylene carbonate (“EC”), and a stabilizer. This second group of solutions was prepared using EC in the place of PC, in order to investigate whether the previous test results using PC-based formulations would display similar behavior as formulations containing other alkylene carbonates. Generally, hydrolysis for aqueous EC solutions is high because of a low degree of steric hindrance; accordingly, EC is not usually used in cleaning applications do to its very high hydrolysis rate. These solutions were stored at 50° C. for 8 weeks and analyzed several times during the test period. The table below lists several samples and their results at week 8, again using GC to determine the area ratio of alkylene carbonate to glycol on the chromatogram, and thus measure the relative rate of hydrolysis from one sample to the next.

| Sample | EC | Water | Stabilizer | EC area % | EG area % | pH |
|---|---|---|---|---|---|---|
| 8 | 4.9 | 95 | 0.1 Citric Acid | 42.95 | 46.53 | 2.67 |
| 9 | 4.9 | 95 | 0.1 Dibasic Ester | 46.56 | 45.87 | 3.7 |
| 10 | 4.5 | 95 | 0.5 Dibasic Ester | 51.29 | 46.75 | 3.02 |
| 11 | 4.0 | 95 | 1.0 Dibasic Ester | 44.9 | 47.75 | 2.8 |
| 12 | 3.5 | 95 | 1.5 Dibasic Ester | 45.69 | 51.99 | 2.68 |
| 13 | 4.5 | 95 | 0.5 NMP | 34.05 | 42.9 | 4.42 |
| 14 | 4.0 | 95 | 1.0 NMP | 25.23 | 33.43 | 4.21 |
| 15 | 3.5 | 95 | 1.5 NMP | 20.21 | 26.27 | 4.10 |
| 16 | 4.9 | 95 | L-Tartaric | 43.87 | 55.17 | 2.62 |
| 17 | 4.9 | 95 | 0.1 Ethyl | 49.95 | 49.79 | 2.98 |
| | | | Lactate | | | |
| 18 | 4.5 | 95 | 0.5 Ethyl | 43.83 | 56.17 | 2.60 |
| | | | Lactate | | | |
| 19 | 4.5 | 95 | 0.5 EG Diacetate | 41.73 | 53.13 | 3.00 |
| 20 | 4.0 | 95 | 1.0 EG Diacetate | 35.81 | 52.34 | 2.81 |
| 21 | 3.5 | 95 | 1.5 EG Diacetate | 30.90 | 51.64 | 2.71 |
| 22 | 4.9 | 95 | 0.1 EEP | 46.55 | 49.22 | 4.05 |
| 23 | 4.5 | 95 | 0.5 EEP | 37.08 | 51.42 | 3.48 |
| 24 | 4.0 | 95 | 1.0 EEP | 37.38 | 44.26 | 3.06 |
| 25 | 3.5 | 95 | 1.5 EEP | 34.47 | 36.23 | 2.89 |
| 26 | 4.9 | 95 | 0.1 Methyl | 47.21 | 52.79 | 2.62 |
| | | | Formate | | | |
| 27 | 4.9 | 95 | 0.1 Lactic Acid | 47.40 | 52.60 | 2.96 |
| control | 5.0 | 95 | None | 42.25 | 57.41 | 4.45 |

The formulations described in the examples below did not successfully reduce the hydrolis of the alkylene carbonate. The method of analysis was GC, used to determine the ratio of alkylene carbonate to glycol by measuring the ratios of the corresponding areas on the chromatogram to thus measure the relative rate of hydrolysis of the various samples. Samples 28-32 lists the performance of these poor performers vs. the control at 16 weeks. Samples 33—lists the performance of the poor performers vs. the control at 8 weeks and 50° C.

| Sample | PC | Water | Stabilizer | PC wt % | PG wt % | pH |
|---|---|---|---|---|---|---|
| 28 | 4.9 | 95 | 1.0 Phosphoric | 80.12 | 19.88 | 1.69 |
| | | | Acid | | | |
| 29 | 4.0 | 95 | 1.0 Maleic Acid | 79.36 | 20.64 | 1.59 |
| 30 | 4.0 | 95 | 1.0 Tartaric Acid | 94.34 | 5.66 | 2.08 |
| 31 | 4.9 | 95 | 0.1 EG Diacetate | 92.02 | 5.99 | 4.38 |
| 32 | 4.0 | 95 | 1.0 EEP | 65.60 | 4.59 | 4.35 |
| control | 5.0 | 95.0 | None | 94.43 | 5.57 | 5.26 |

| Sample | EC | Water | Stabilizer | EC | EG | pH |
|---|---|---|---|---|---|---|
| 33 | 4.5 | 95 | 0.5 Citric Acid | 32.75 | 66.68 | 2.34 |
| 34 | 4.0 | 95 | 1.0 Citric Acid | 21.94 | 69.37 | 2.17 |
| 35 | 3.5 | 95 | 1.5 Citric Acid | 18.40 | 70.54 | 2.07 |
| 36 | 4.9 | 95 | 0.1 NMP | 37.12 | 57.52 | 4.52 |
| 37 | 4.5 | 95 | 0.5 L-Tartaric Acid | 31.19 | 68.26 | 2.22 |
| 38 | 4.0 | 95 | 1.0 L-Tartaric Acid | 24.70 | 74.74 | 2.08 |
| 39 | 3.5 | 95 | 1.5 L-Tartaric Acid | 14.85 | 85.0 | 1.96 |
| 40 | 4.0 | 95 | 1.0 Ethyl Lactate | 41.76 | 57.99 | 2.45 |
| 41 | 3.5 | 95 | 1.5 Ethyl Lactate | 40.92 | 59.08 | 2.34 |
| 42 | 4.9 | 95 | 0.1 EG Diacetate | 42.44 | 57.56 | 3.57 |
| 43 | 3.5 | 95 | 0.5 Methyl Formate | 39.91 | 59.74 | 2.31 |
| 44 | 4.0 | 95 | 1.0 Methyl Formate | 25.22 | 74.78 | 2.24 |
| 45 | 3.5 | 95 | 1.5 Methyl Formate | 19.08 | 80.92 | 2.15 |
| 46 | 4.5 | 95 | 0.5 Lactic Acid | 41.17 | 58.73 | 2.62 |
| 47 | 4.0 | 95 | 1.0 lactic acid | 36.32 | 63.32 | 2.43 |
| 48 | 3.5 | 95 | 1.5 Lactic Acid | 28.29 | 71.56 | 2.32 |
| 49 | 4.9 | 95 | 0.1 Oxalic Acid | 21.53 | 78.37 | 2.17 |
| 50 | 4.5 | 95 | 0.5 Oxalic Acid | 2.52 | 97.33 | 1.59 |
| 51 | 4.0 | 95 | 1.0 Oxalic Acid | 0.47 | 99.44 | 1.41 |
| 52 | 3.5 | 95 | 1.5 Oxalic Acid | 0.00 | 99.68 | 1.28 |
| control | 5.0 | 95 | None | 42.25 | 57.41 | 4.45 |

What is claimed is:

1) A cleaning fluid which comprises:
a) an alkylene carbonate selected from the group consisting of: ethylene carbonate; propylene carbonate; butylene carbonate; and glycerine carbonate;
b) an effective alkylene carbonate hydrolysis-inhibiting amount of an ester selected from the group consisting of: 3-ethoxyethylproprionate; ethylene glycol diacetate, ethyl lactate, dibasic ester DBE®, or methyl formate; and
c) water,
wherein water is present in any amount between 20.00% and 95.00% by weight based upon the total weight of said composition, including every hundredth percentage therebetween, and wherein the pressure in the headspace of a sealed container containing such composition is less than 3 pounds per square inch above atmospheric pressure after exposure of such sealed container containing such composition to a temperature of 50 degrees Centigrade for a time period of 12 hours.

2) A composition according to claim 1 wherein said ester is present in any amount between 0.01-2.00% by weight based upon the total weight of the composition.

3) A composition according to claim 1 wherein said ester is present in any amount between 0.01-0.20% by weight based upon the total weight of the composition.

4) A cleaning fluid which comprises:
a) an alkylene carbonate selected from the group consisting of: ethylene carbonate; propylene carbonate; butylene carbonate; and glycerine carbonate;
b) an effective alkylene carbonate hydrolysis-inhibiting amount of an acid selected from the group consisting of. lactic acid, tartaric acid, citric acid, phosphoric acid, or maleic acid; and
c) water,
wherein water is present in any amount between 20.00% and 95.00% by weight based upon the total weight of said composition, including every hundredth percentage therebetween, and wherein the pressure in the headspace of a sealed container containing such composition is less than 3 pounds per square inch above atmospheric pressure after exposure of such sealed container containing such composition to a temperature of 50 degrees Centigrade for a time period of 12 hours.

5) A composition according to claim 4 wherein said acid is present in any amount between 0.01-2.00% by weight based upon the total weight of the composition.

6) A composition according to claim 4 wherein said acid is present in any amount between 0.01-0.20% by weight based upon the total weight of the composition.

7) A cleaning fluid which comprises:
a) an alkylene carbonate selected from the group consisting of ethylene carbonate; propylene carbonate; butylene carbonate; and glycerine carbonate;
b) an effective alkylene carbonate hydrolysis-inhibiting amount of N-methylpyrrolidone; and
c) water,
wherein water is present in any amount between 20.00% and 95.00% by weight based upon the total weight of said composition, including every hundredth percentage therebetween, and wherein the pressure in the headspace of a sealed container containing such composition is less than 3 pounds per square inch above atmospheric pressure after exposure of such sealed container containing such composition to a temperature of 50 degrees Centigrade for a time period of 12 hours.

8) A composition according to claim 7 wherein of N-methylpyrrolidone is present in any amount between 0.01-2.00% by weight based upon the total weight of the composition.

9) A composition according to claim 7 wherein of N-methylpyrrolidone is present in any amount between 0.01-0.20% by weight based upon the total weight of the composition.
